(19) United States
(12) Patent Application Publication
(10) Pub. No.: US 2016/0261786 A1
(43) Pub. Date: Sep. 8, 2016

(54) Wafer Inspection Apparatus Using Three-Dimensional Image

(71) Applicant: Samsung Electronics Co., Ltd., Suwon-si (KR)

(72) Inventors: Jeong-ho Ahn, Hwaseong-si (KR); Yu-sin Yang, Seoul (KR); Yun-jung Jee, Seongnam-si (KR); Woo-seok Ko, Seoul (KR)

(21) Appl. No.: 14/959,443

(22) Filed: Dec. 4, 2015

(30) Foreign Application Priority Data
Mar. 3, 2015 (KR) 10-2015-0029856

(51) Int. Cl. H04N 5/232; G06T 7/00; H04N 5/225; H04N 13/02

(52) U.S. Cl. CPC H04N 5/23212; H04N 13/02; G06T 7/0004; H04N 5/2256; H04N 5/2251; G06T 2207/30148; G06T 2200/04

(57) ABSTRACT

Provided is a wafer inspection apparatus using three-dimensional (3D) images, which apparatus may acquire a 3D image by adjusting a focal position at a high speed, and inspect a wafer by using the 3D image so that a 3D inspection operation may be precisely performed on patterns formed on the wafer at a high speed. The wafer inspection apparatus may include a stage on which a wafer is disposed, an optical apparatus configured to acquire an image of a pattern formed on the wafer by using a scan method, a focus adjusting unit configured to change a focal position of light irradiated to the wafer according to a scan speed of the optical apparatus, and an image processor configured to integrate images corresponding to focal positions and generate and analyze 3D images.

### CROSS-REFERENCE TO RELATED APPLICATION

This application claims the benefit of Korean Patent Application No. 10-2015-0029856, filed on Mar. 3, 2015, the disclosure of which is incorporated by reference herein in its entirety.

### BACKGROUND

The inventive concept relates to a wafer inspection apparatus, and more particularly, to a wafer inspection apparatus capable of detecting defects in a wafer.

In recent years, with the miniaturization and complication of semiconductor processes, a wide variety of defects may affect yield. Although some defects occur on a surface of a wafer, other defects may occur in an inner layer (i.e., a sub-layer). However, typical methods or apparatuses for inspecting wafers provide only lateral information regarding positions of defects and are deficient in providing depth-wise information regarding defects, and thus, it may be difficult to precisely monitor the defects. Meanwhile, with respect to methods of estimating a depth of particles in a wafer, there are a holography analysis method, a scanning electron microscope (SEM) analysis method, and a transmission electron microscope (TEM) analysis method. However, such analysis methods are inappropriate for a method of inspecting defects. In particular, since the SEM or TEM analysis method involves destroying samples, the SEM or TEM analysis method is not suitable for an in-line monitoring tool.

### SUMMARY

The inventive concept provides a wafer inspection apparatus using three-dimensional (3D) images, which may acquire 3D images by adjusting a focal position at a high speed and inspect a wafer by using the 3D images so that the wafer inspection apparatus may precisely perform a 3D inspection process on patterns formed on the wafer at a high speed.

According to an aspect of the inventive concept, there is provided a wafer inspection apparatus including a stage on which a wafer is disposed, an optical apparatus configured to acquire an image of a pattern formed on the wafer, by using a scan method, a focus adjusting unit configured to change a focal position of light irradiated to the wafer according to a scan speed of the optical apparatus, and an image processor configured to integrate images corresponding to focal positions and generate and analyze 3D images.

According to another aspect of the inventive concept, there is provided a wafer inspection apparatus including a stage on which a wafer is disposed, wherein the stage is configured to move to perform a scan operation, an image acquiring apparatus configured to receive light reflected by the wafer and acquire an image, an optical system configured to irradiate light to the wafer and transmit the light reflected by the wafer to the image acquiring apparatus, a focus adjusting unit configured to change a focal position of the light irradiated to the wafer according to a scan speed of the optical system, and an image processor configured to integrate images corresponding to focal positions, generate a 3D image, and analyze the 3D image.

According to another aspect of the inventive concept, there is provided a wafer inspection apparatus. The apparatus includes a stage configured to support a wafer that is an inspection target, a focus adjusting unit, an optical apparatus and an image processor. The focus adjusting unit is configured to change a focal position of light irradiated to the wafer. The optical apparatus is configured to irradiate light to the wafer at a plurality of focal positions, to receive light reflected from the wafer for each focal position, and to acquire an image for each focal position. The image processor is configured to receive the plurality of images from the optical apparatus for each focal position, to integrate the images, to generate a 3D image based on the integrated images, and to analyze the 3D image to perform a 3D defect inspection of the wafer.

### BRIEF DESCRIPTION OF THE DRAWINGS

Example embodiments of the inventive concept will be more clearly understood from the following detailed description taken in conjunction with the accompanying drawings in which:

FIG. 1 is a block diagram of a wafer inspection apparatus according to example embodiments;

FIG. 2 is a schematic view of the wafer inspection apparatus of FIG. 1;

FIG. 3A is a conceptual diagram for explaining how much a focal position may be changed by varying an optical path according to a refractive index;

FIG. 3B is a graph showing a variation in focal position according to a refractive index;

FIGS. 4A and 4B are schematic perspective views of an acousto-optic tunable filter (AOTF) and a liquid crystal (LC) device that may be specifically used in relation to the control of an optical path;

FIGS. 5A to 5C are block diagrams of a wafer inspection apparatus according to example embodiments;

FIGS. 6A to 6F are schematic diagrams for explaining scan methods used for a wafer inspection apparatus according to example embodiments;

FIGS. 7A and 7B are schematic diagrams for explaining a method of performing a scan operation while changing a focal position in a wafer inspection apparatus according to example embodiments;

FIG. 8A is a graph showing that a focal position is changed at predetermined time intervals in a wafer inspection apparatus according to example embodiments;

FIG. 8B is a schematic diagram showing that a principle on which the focal position of FIG. 8A is changed is applied to a time delayed integration (TDI) scan method;

FIG. 9A is a graph showing that a focal position is periodically changed in a wafer inspection apparatus according to example embodiments; and

FIGS. 9B to 9D are schematic diagrams showing that a principle on which the focal position of FIG. 9A is changed is applied to each of a TDI scan method, a multi-spot scan method, and a line scan method.

### DETAILED DESCRIPTION OF THE EMBODIMENTS

The inventive concept will now be described more fully hereinafter with reference to the accompanying drawings, in which example embodiments of the inventive concept are shown. This inventive concept may, however, be embodied in different forms and should not be construed as limited to the embodiments set forth herein. Rather, these embodiments are provided so that this disclosure is thorough and complete and fully conveys the scope of the inventive concept to one skilled in the art.

It will be understood that when an element or layer is referred to as being “on”, “connected to” or “coupled to” another element or layer, it can be directly on, connected or coupled to the other element or layer or intervening elements or layers may be present. In the drawings, the thicknesses of layers and regions may be exaggerated for clarity. Descriptions of components and processing techniques that are irrelevant to the embodiments of the inventive concept may be omitted for brevity. Like reference numerals refer to like elements throughout. The terminology used herein to describe embodiments of the inventive concept is not intended to limit the scope of the inventive concept.

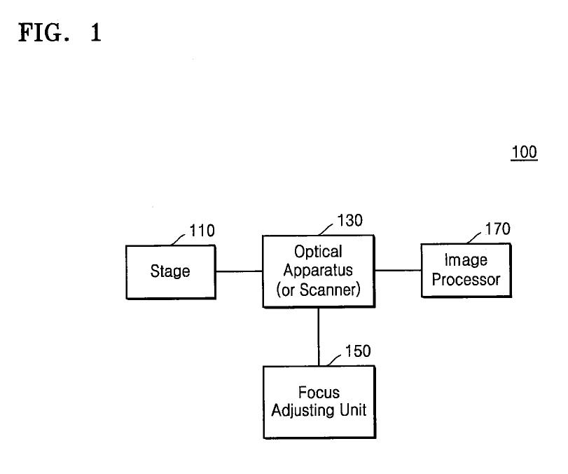

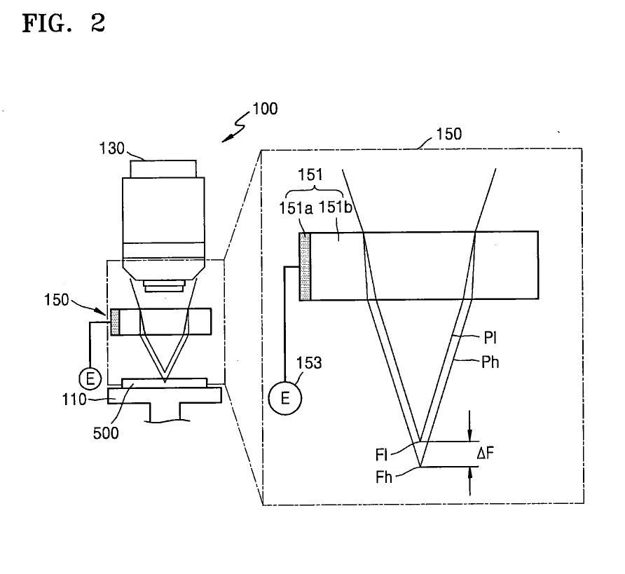

FIG. 1 is a block diagram of a wafer inspection apparatus 100 according to example embodiments, and FIG. 2 is a schematic diagram of the wafer inspection apparatus 100 of FIG. 1.

Referring to FIGS. 1 and 2, the wafer inspection apparatus 100 according to the present embodiment may include a stage 110, an optical apparatus 130, a focus adjusting unit 150, and an image processor 170.

The stage 110 may be an apparatus configured to fix and support a wafer 500 that is an inspection target. The wafer 500 may be disposed on the stage 110 during an inspection process, and the stage 110 may move the disposed wafer 500 in an x direction, a y direction, and a z direction. Although the wafer 500 is described as an example of an inspection target, the inspection target is not limited to the wafer 500 and may be one of various semiconductor apparatuses, for example, a semiconductor package, a semiconductor chip, and a display panel, which need to be 3-dimensionally inspected.

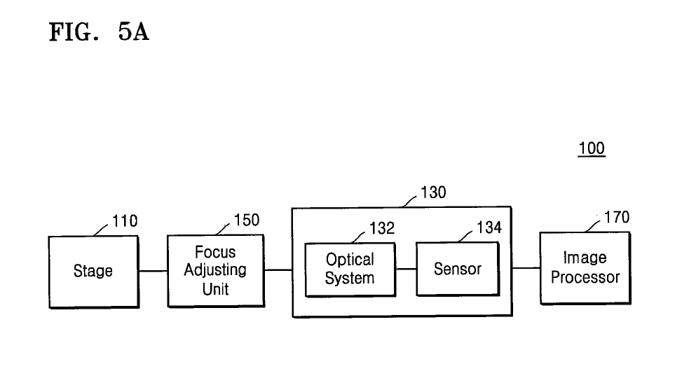

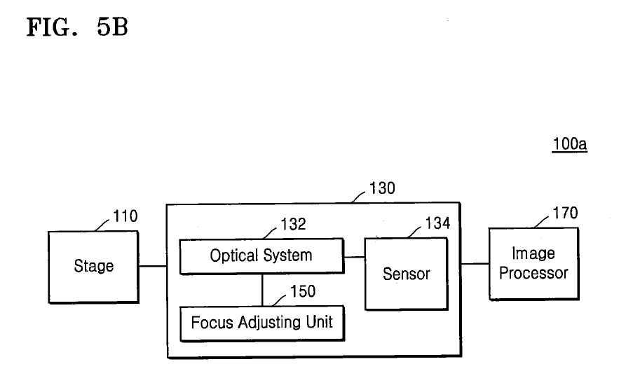

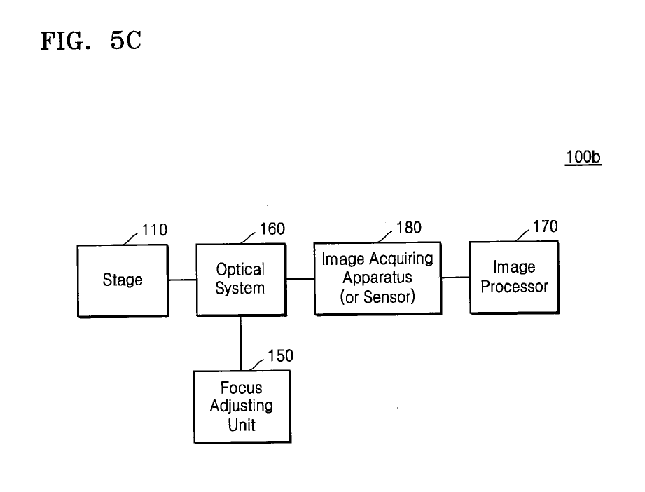

The optical apparatus 130 may receive light reflected by the wafer 500 and acquire an image of patterns formed on the wafer 500. The optical apparatus 130 may include an optical system (refer to 132 in FIG. 5A) and a sensor (refer to 134 in FIG. 5A). The optical system may irradiate light to the wafer 500 and transmit light reflected by the wafer 500 to the sensor. The optical system will be described in further detail later with reference to FIG. 5A.

The sensor may receive light reflected by the wafer 500 and acquire images. The sensor may include various kinds of sensors. For example, the sensor may include a charged coupled device (CCD) sensor, a time delayed integration (TDI) sensor, a photo multiplier tube (PMT) or a photodiode (PD) array sensor, and a line scan CCD sensor.

The optical apparatus 130 may acquire an image of the wafer 500 using a scan method by using the sensor. A scan operation may be performed by moving the optical apparatus 130 or moving the wafer 500 using the stage 110. For example, a scan operation of the wafer inspection apparatus 100 according to the present embodiment may be performed by moving the stage 110.

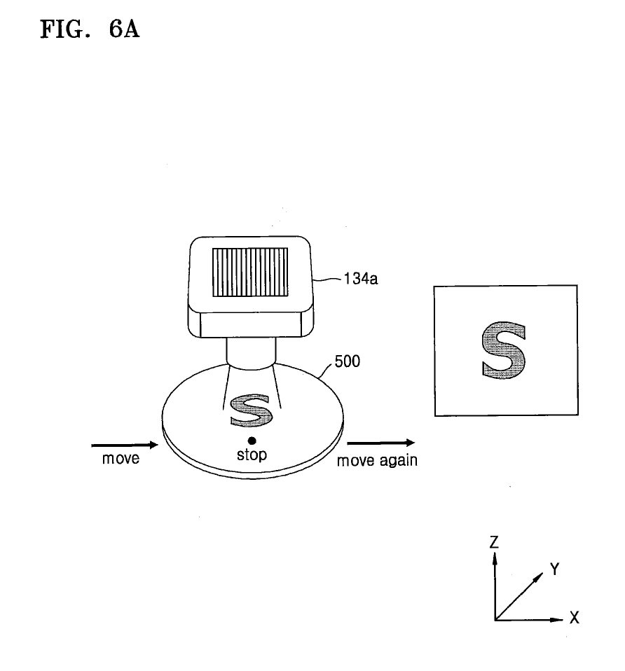

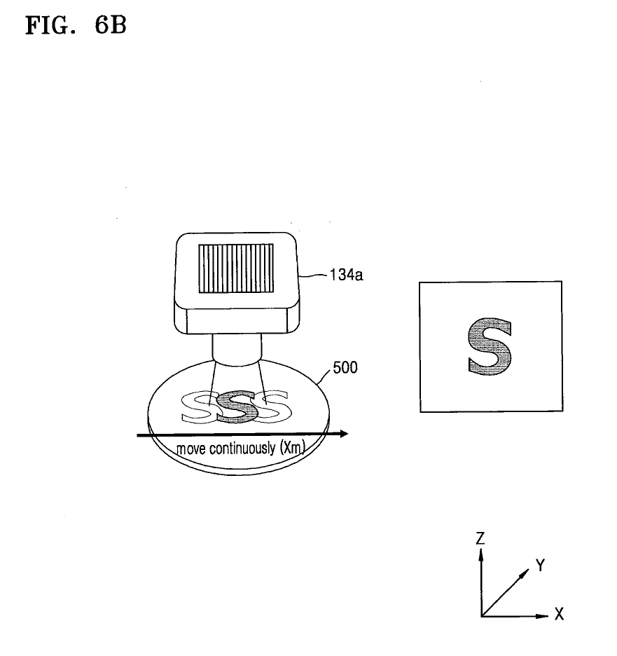

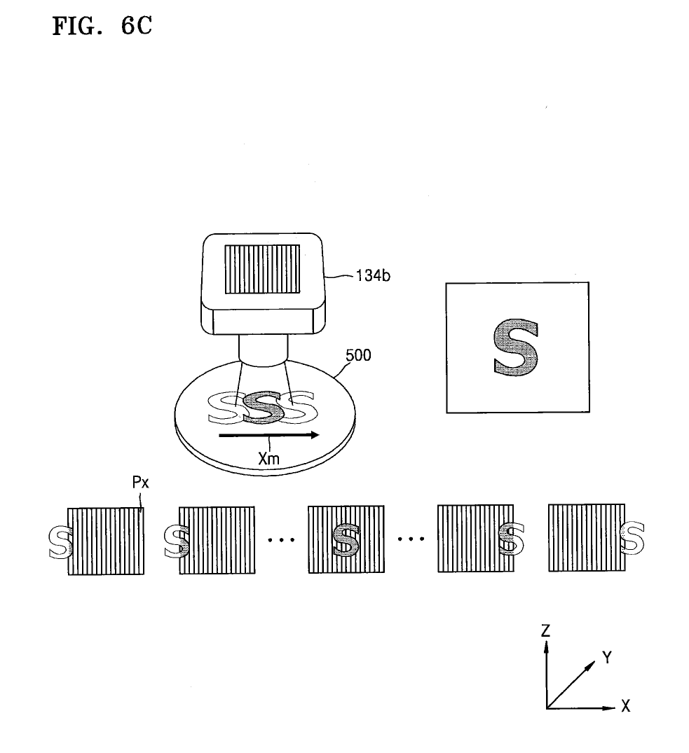

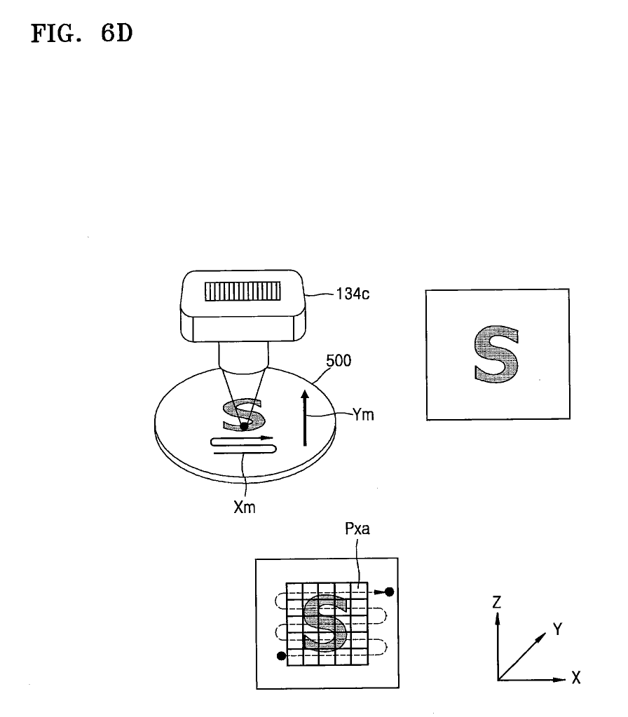

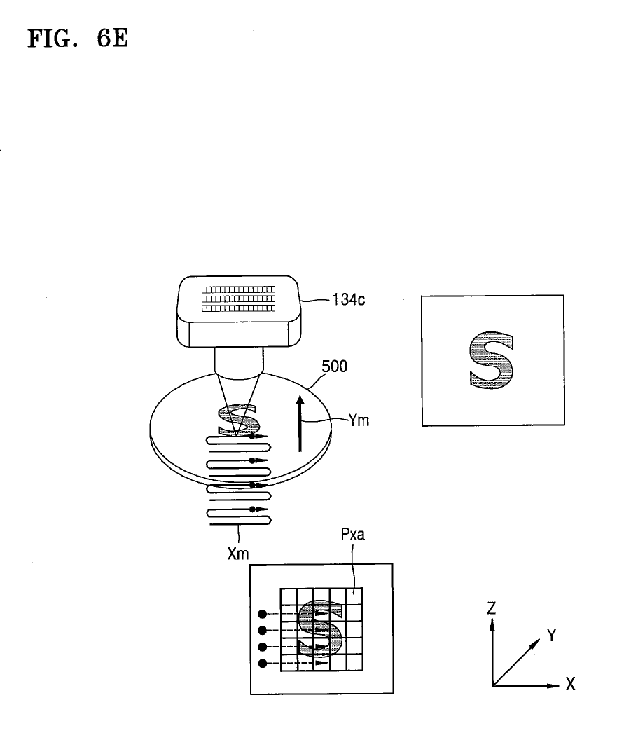

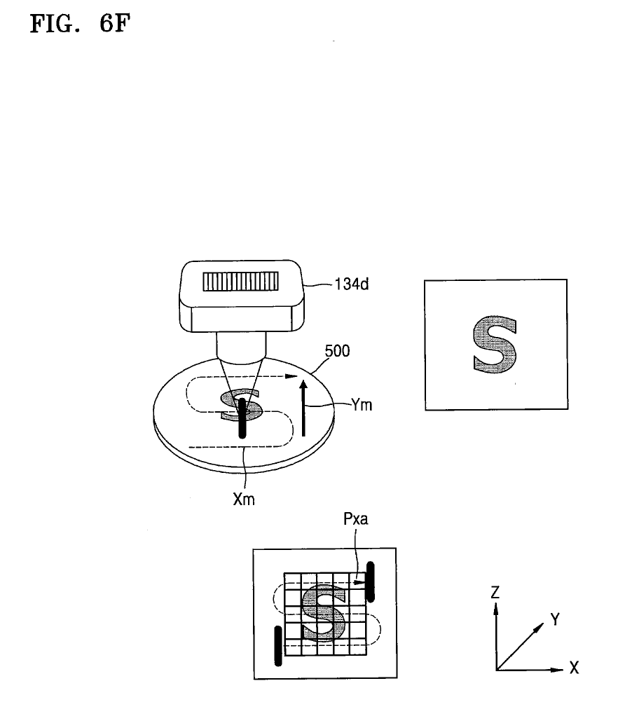

Meanwhile, the scan method may include various scan methods, such as a leap-and-scan scan method, an on-time scan method, a TDI scan method, a spot scan method, a multi-spot scan method, and a line scan method. Each of the scan methods will be described in further detail below with reference to FIGS. 6A to 6F.

Alternatively, the optical apparatus 130 may scan the wafer 500 while changing a focal position of light irradiated to the wafer 500 by using the focus adjusting unit 150. Thus, the optical system 130 may acquire a plurality of images of the wafer 500, which is an inspection target, according to focal positions.

The focus adjusting unit 150 may change a focal position of light irradiated to the wafer 500. The focus adjusting unit 150 may electrically control an optical path of light irradiated to the wafer 500 and change the focal position of the light.

More specifically, the focus adjusting unit 150 may include a plate 151 and a driver 153. The driver 153 may supply electricity to the plate 151, and a refractive index of the plate 151 may be changed due to the supplied electricity. The focus adjusting unit 150 may change an optical path of light passing through the plate 151 and change a focal position of the light. For example, light irradiated by the optical apparatus 130 may be transmitted through the plate 151 and irradiated to the wafer 500. When electricity is applied to the plate 151, a refractive index of the plate 151 may be changed so that the optical path of the light may be changed to change the focal position of the light.

The plate 151 may include an acoustic-optic (AO) device or a liquid crystal (LC) device of which a refractive index varies with the application of electricity. In the focus adjusting unit 150 according to the present embodiment, the plate 151 may include, for example, a piezo transducer 151a and an AO crystal 151b. When a radio-frequency (RF) current is applied to the piezo transducer 151a, ultrasonic waves may be generated. Thus, lattices of the AO crystal 151b may be changed to change a refractive index of the AO crystal 151b.

As seen on a right enlarged view of FIG. 2, an angle of refraction of light incident to the plate 151 may vary according to the refractive index of the plate 151. In other words, as a difference in refractive index between mediums to which light is incident (e.g., between the air and the plate 151) increases, an angle of refraction may increase. Thus, an optical path may be changed so that a focal position may change (e.g., become distant or more distant).

More specifically, as a refractive index of the plate 151 increases (refer to Ph), an angle at which light is refracted may increase (an angle of refraction with respect to a normal line of an incidence surface may be reduced). Thus, an optical path may increase so that a focal position Fh may become distant (e.g., further away). In contrast, when a refractive index of the plate 151 is reduced (refer to Pl), an angle at which light is refracted may be reduced (an angle of refraction with respect to the normal line of the incidence surface may increase). Thus, an optical path may be reduced so that a focal position Fl may become close or closer. Therefore, a difference ΔF between the focal position Fh corresponding to a high refractive index of the plate 151 and the focal position Fl corresponding to a low refractive index of the plate 151 may occur. Also, as shown in FIG. 2, a difference between optical paths may occur in the plate 151.

In the focus adjusting unit 150 according to the present embodiment, a refractive index of the plate 151 may be changed by applying electricity through the driver 153. An optical path may vary within a range of several microseconds (μs) to several milliseconds (ms) due to the variation in refractive index of the plate 151 with the application of electricity. Accordingly, the focus adjusting unit 150 according to the present embodiment may hardly affect a scan speed of the optical apparatus 130 but change a focal position at a high speed. Thus, the optical apparatus 130 may perform a scan process in various manners and easily acquire images corresponding to focal positions at a high speed. Meanwhile, the focus adjusting unit 150 may be disposed inside the optical apparatus 130 or outside the optical apparatus 130.

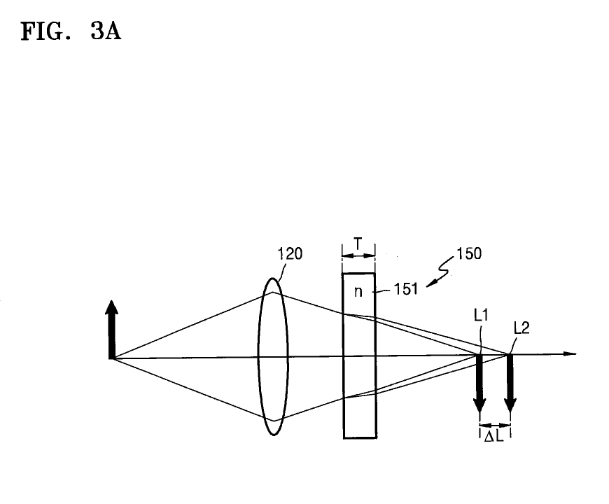

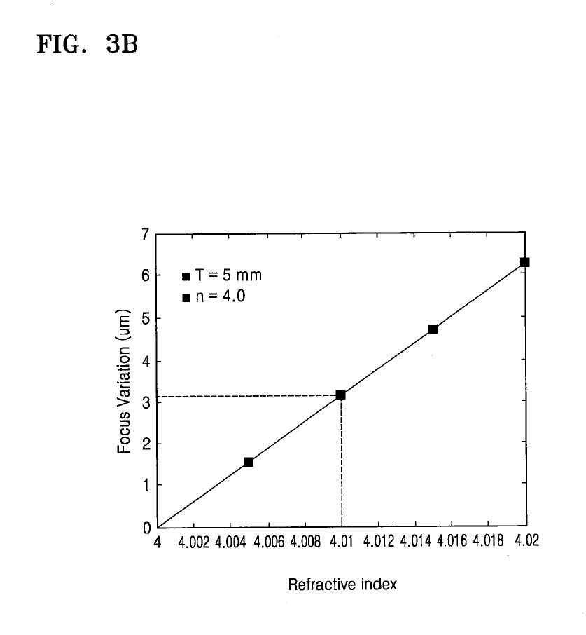

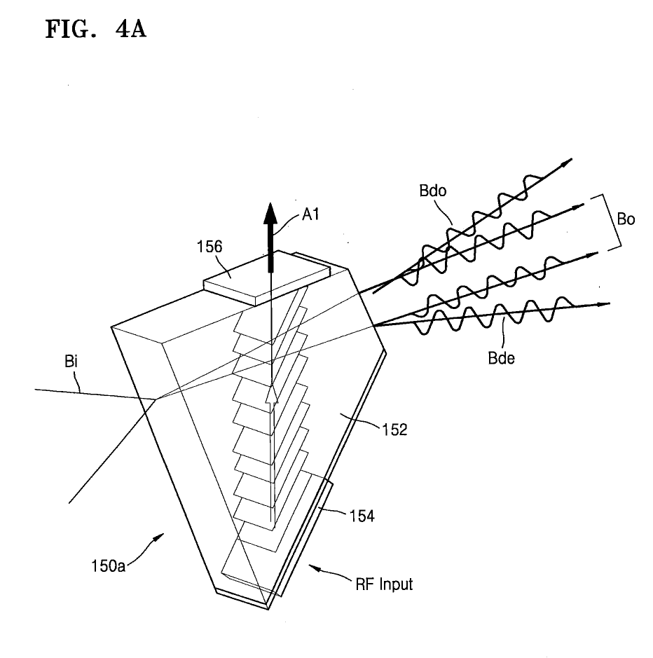

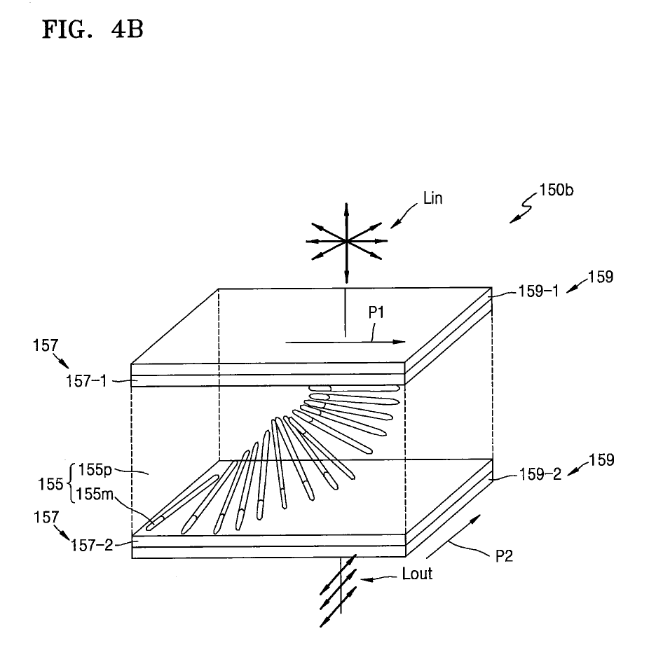

The focus adjusting unit 150 will be described in further detail below with reference to FIGS. 3A to 4B.

The image processor 170 may integrate a plurality of images corresponding to focal positions and generate 3-dimensional (3D) images. Also, the image processor 170 may compare and analyze the generated 3D images relative to or with each other and perform a 3D defect inspection operation on the wafer 500.

Hereinafter, the principles by which the wafer inspection apparatus 100 according to the present embodiment obtains images corresponding to focal positions, integrates the images to generate 3D images, and analyzes the 3D images to detect defects will be described in detail.

Initially, the images corresponding to the focal positions may be obtained by using the following method. Specifically, when a surface or any plane of a wafer 500 that is an inspection target is in an in-focus position, the optical apparatus 130 may perform a scan operation while changing a focal position within a range of about ±several micrometers (μm) from the in-focus position. The scan operation may be performed in any one focal position along any one direction (e.g., an x direction) on an x-y plane perpendicular to a z-axis. Next, the focal position may be changed to the next focal position, and a scan operation may be performed again along the x direction. In some cases, a focal position may be changed while a scan operation is being performed along the x direction.

The focal position may be gradually changed in predetermined units from a minimum focal position to a maximum focal position or from the maximum focal position to the minimum focal position. Also, the focal position may be changed at any one of two end portions of the x direction, which is a scan direction. Alternatively, when a scan operation is performed not on a fixed y-axis value but on the entire x-y plane, after a scan operation is performed on a first y-axis value in a first focal position, a scan operation may be performed on a second y-axis value in a second focal position.

For reference, if defects are present at different depths in the same position on the x-y plane, when images of a wafer are obtained by performing a typical scan operation in a fixed focal position, only the same or almost the same optical signals may be obtained irrespective of the depths of the defects. In other words, when a typical scan operation is performed in a fixed focal position, only lateral information regarding the defects may be obtained, but information regarding the depths of the defects may not be obtained. However, when images of the wafer are obtained by performing a scan operation while changing a focal position, information regarding the depths of the defects may be obtained in the following process.

Initially, a scan operation may be performed at each focal position by using the above-described method to acquire 2D optical images. The 2D optical images may be digital images on which a digital signal processing process has been performed. The 2D optical images may be transmitted to an image processor (e.g., an analyzing computer) on which digital signal processing algorithms are installed. Next, an optical intensity profile may be extracted from each of the 2D optical images corresponding to focal positions with respect to any one fixed y-axis value. The optical intensity profile may be extracted from the 2D optical images by using a predetermined algorithm installed on the analyzing computer.

Thereafter, optical intensity images corresponding to focal positions may be generated by integrating optical intensity profiles. The optical intensity images corresponding to the focal positions may be embodied by assigning colors corresponding to optical intensities on an x-z plane. Here, the assigned colors are not representative of precise values but only relative numerical values corresponding to the optical intensities.

In a rectangular optical intensity image, an x-axis may be a direction in which a scan operation is performed and a z-axis may be a direction in which a focal position changes (i.e., a depth-wise direction of a focus). Also, in the optical intensity image, the x-axis may be within a range of ±several μm from a position x (=0) in which a defect is present and the z-axis may be within a range of ±several μm (e.g., ±2 μm) from an in-focus position z (=0). Meanwhile, an in-focus position may be arbitrarily determined. For example, a portion in which a defect is present may be determined as the in-focus position. In another example, a surface of the wafer 500 may be determined as the in-focus position. Since the portion in which the defect is present cannot be precisely detected, the surface of the wafer 500 may be typically determined as the in-focus position. Meanwhile, a 3D optical intensity image, for example, the above-described 3D image, may be obtained by expanding a fixed y-axis value into a predetermined range. Also, since even an optical intensity image of the fixed y-axis value includes information regarding a depth of the defect, that is, z-axis information, the optical intensity image of the fixed y-axis value may also be regarded as the above-described 3D image.

The obtained optical intensity image may be compared with comparison target images stored in a library. The comparison target images stored in the library may be distinguished based on various standards, such as wafer types, positions of defects on an x-y plane, and depths of the defects. When there is a comparison target image that matches the obtained optical intensity image, depth information regarding a defect in the wafer 500 may be obtained based on depth information of a defect in the matched comparison target image. Meanwhile, the inventive concept is not limited to the optical intensity image, and various pieces of data, such as a ‘differential optical intensity profile’ of the optical intensity profile, ‘differences’ between adjacent optical intensity profiles, and ‘differences’ between adjacent optical intensity images, may be used to obtain depth information.

The comparison target images stored in the library may be pieces of data obtained by conducting a simulation or an experiment on the wafer. Also, optical intensity images acquired by performing a scan operation while changing a focal position as described above may be stored in the library and utilized as the comparison target images. Also, a vertical-section scanning electron microscope (SEM) or transmission electron microscope (TEM) analysis method may be performed on the wafer, and new comparison target images may be generated or the previous comparison target images may be updated based on SEM or TEM analysis results. For instance, when there are large differences between the SEM or TEM analysis results and pieces of simulation data, an updating process of discarding or changing the simulation data may be performed.

The wafer inspection apparatus 100 according to the present embodiment may acquire images corresponding to focal positions, integrate the images, generate 3D images, and analyze the 3D images. Thus, the wafer inspection apparatus 100 may perform a 3D defect inspection operation on the wafer 500. Also, the wafer inspection apparatus 100 according to the present embodiment may adopt the focus adjusting unit 150 configured to change a focal position by using a variation in refractive index due to application of electricity, and change the focal position at a high speed. Accordingly, the wafer inspection apparatus 100 according to the present embodiment may acquire images corresponding to focal positions at a high speed by using various scan processes, generate 3D images, and analyze the 3D images. Therefore, the wafer inspection apparatus 100 according to the present embodiment may perform a 3D defect inspection operation on the wafer 500 at a high speed.

FIG. 3A is a conceptual diagram for explaining how much a focal position may be changed by varying an optical path according to a refractive index. In FIG. 3A, a convex lens 120 may be, for example, an objective lens. A left arrow of the convex lens 120 may be an object, and right arrows of the convex lens 120 may be inverse images formed in focal positions.

Referring to FIG. 3A, when a refractive index of the plate 151 is n and a thickness of the plate 151 is T, a focal length L may be expressed by the following Equation 1:

L=(n−1)T/n (1).

If a first refractive index n1 is 4.0, a second refractive index n2 is 4.01, and the plate 151 has a thickness of about 5,000 μm, the focal length L1 corresponding to the first refractive index n1 may be about 3,750 μm and the focal length L2 corresponding to the second refractive index n2 may be about 3,753 μm. Accordingly, a focal position variation ΔL may be about 3 μm.

Based on the above-described calculation results, it may be concluded that when a variation in the refractive index of the plate 151 is about 0.01, the focal position variation ΔL of about 3 μm may occur. Meanwhile, as described above, the variation in the refractive index of the plate 151 may be performed within a range of about several μs to about several ms. Thus, when a range in which a focal position changes is determined as a range of about ±2 μm, it may be seen that a scan operation may be performed at a high speed according to the changed focal position within a small refractive index variation.

FIG. 3B is a graph showing a variation in focal position according to a refractive index. In FIG. 3B, the abscissa denotes a refractive index, and the ordinate denotes a variation in focal position (refer to ΔL in FIG. 3A) in micrometers (μm).

As shown in FIG. 3B, a variation in focal position relative to a variation in refractive index may be graphically linear to some extent. Also, as calculated in FIG. 3A, it may be confirmed that while a refractive index varies by as much as about 0.01, a focal position varies by as much as about 3 μm. Meanwhile, it may be confirmed that while a refractive index varies by as much as 0.02, a focal position varies by as much as about 6 μm due to the linear relationship. Meanwhile, when a variation in refractive index departs from a specific range, a linear relationship between a variation in refractive index and a variation in focal position may not be maintained.

Based on the linear relationship between the variation in refractive index and the variation in focal position, a focal position may be changed at predetermined intervals by varying a refractive index of the plate 151 at predetermined intervals.

FIGS. 4A and 4B are schematic perspective views of an acousto-optic tunable filter (AOTF) and a liquid crystal (LC) device, respectively, that may be specifically used in relation to control of an optical path.

Referring to FIG. 4A, an AOTF 150a may be a kind of filter that is developed by using a tellurium oxide (TeO₂) crystal 152 having excellent acousto-optical (AO) characteristics. The AOTF 150a may function as a diffraction grating for incident white light, select only a desired specific wavelength, and operate as an optical band-pass filter having a very narrow bandwidth. Meanwhile, the selected wavelength may be determined by a frequency (e.g., a radio frequency (RF)) required to drive a piezo transducer 154 that is attached to an AO crystal (or the TeO₂ crystal 152). Thus, light having a desired wavelength may be continuously obtained by tuning a driving frequency of the AOTF 150a. Also, when a frequency of a driver is changed to change a wavelength of output light, crystal lattices may vary in a time period of about 20 μs. Thus, the wavelength of output light may be changed almost in real time.

In FIG. 4A, an acoustic absorber 156 may be configured to absorb acoustic waves, and an arrow A1 in the acoustic absorber 156 may refer to an optical axis of the TeO₂ crystal 152. As shown, when focused non-polarized incident light Bi is incident to the AOTF 150a, the focused non-polarized incident light Bi may be separated into non-diffracted zero-order beams Bo, diffracted ordinary polarized waves Bdo, and diffracted extraordinary polarized waves Bde due to acoustic waves traveling along an optical axial direction and output from the AOTF 150a. Here, the traveling acoustic waves may be generated due to high-frequency waves, such as RF waves input from the piezo transducer 154.

Referring to FIG. 4B, an LC device 150b may include a composite material layer 155, a transparent electrode plate 157, and a polarizer 159.

The composite material layer 155 may include a polymer film 155p and LC molecules 155m. The composite material layer 155 may have a structure in which a plurality of LC molecules 155m are distributed randomly in the polymer film 155p. When the composite material layer 155 is inserted between two transparent electrode plates 157 and an electric field is applied to the composite material layer 155, as shown in FIG. 4B, directions of the LC molecules 155m may be oriented toward an electric field to transmit light, and thus, the composite material layer 155 may be transparent. Also, light may be P-polarized or S-polarized due to the oriented LC molecules 155m. More specifically, an upper polarizing plate 159-1 may be disposed on an upper transparent electrode plate 157-1, and a lower polarizing plate 159-2 may be disposed under a lower transparent electrode plate 157-2. The upper polarizing plate 159-1 may transmit P-polarized light or S-polarized light. Conversely, the lower polarizing plate 159-2 may transmit S-polarized light or P-polarized light. For example, in a case where the upper polarizing plate 159-1 is a P-polarizing plate and the lower polarizing plate 159-2 is an S-polarizing plate, when unpolarized light Lin is incident to the LC device 150b, only P-polarized light may be first transmitted through the upper polarizing plate 159-1, polarized by the composite material layer 155, transformed into S-polarized light, and transmitted through the lower polarizing plate 159-2. Here, P1 denotes a polarization direction of the upper polarizing plate 159-1, and P2 denotes a polarization direction of the lower polarizing plate 159-2.

Meanwhile, when an electric field is removed, a direction of LC molecules may be disordered due to surface anchoring energy so that incident light may be scattered and the composite material layer 155 may become opaque. That is, light incident to the composite material layer 155 may not be transmitted through the lower polarizing plate 159-2.

The transparent electrode plate 157 may be formed of both a conductive material and a transparent material that may transmit light. For example, the transparent electrode plate 157 may be formed of indium tin oxide (ITO), antimony tin oxide (ATO), aluminum zinc oxide (AZO), indium zinc oxide (IZO), indium zinc tin oxide (IZTO), SnO₂, In₂O₃, or carbon nanotubes (CNTs). In the LC device 150b according to the present embodiment, the transparent electrode plate 157 may be formed of ITO.

In the LC device 150b, the alignment of the LC molecules 155m due to application of electricity may adjust to a variation in refractive index. Accordingly, an optical path may be changed by appropriately using the alignment of the LC molecules 155m so that a focal position may vary. In the LC device 150b, a focal position may vary within a range of several ms according to a refractive index.

FIGS. 5A to 5C are block diagrams of a wafer inspection apparatus 100 according to example embodiments.

Referring to FIG. 5A, the wafer inspection apparatus 100 according to the present embodiment shows the wafer inspection apparatus 100 of FIG. 1 in more detail. An optical apparatus 130 may include an optical system 132 and a sensor 134. The optical system 132 may include a plurality of lenses including an objective lens. As described above, the sensor 134 may be any one of a CCD sensor, a TDI sensor, a PMT (or PD) array sensor, and a line scan CCD sensor.

A focus adjusting unit 150 may be disposed between a stage 110 and the optical apparatus 130 outside the optical apparatus 130. As described above, the focus adjusting unit 150 may change a focal position of light at a high speed with the application of electricity. For example, the focus adjusting unit 150 may include an AO device or an LC device of which a refractive index varies due to application of electricity.

Referring to FIG. 5B, a wafer inspection apparatus 100a according to the present embodiment may differ from the wafer inspection apparatus 100 of FIG. 5A in that a focus adjusting unit 150 is disposed in the optical apparatus 130. In other words, the focus adjusting unit 150 may be disposed in the optical apparatus 130 and interlocked or integrated with the optical system 132. For example, the focus adjusting unit 150 may be disposed between lenses included in the optical system 132. Also, the focus adjusting unit 150 may be disposed in the optical system 132 and function as a portion of the optical system 132. The focus adjusting unit 150 according to the present embodiment may also change an optical path with the application of electricity and vary a focal position of light incident to the wafer (refer to 500 in FIG. 2).

Referring to FIG. 5C, a wafer inspection apparatus 100b according to the present embodiment may differ from the wafer inspection apparatus 100 of FIG. 5A in that an optical system 160 operates as a separate constituent element from an image acquiring apparatus 180. Specifically, in the wafer inspection apparatus 100b according to the present embodiment, the image acquiring apparatus 180 (e.g., a sensor) may not be unified with an optical system 160 but disposed separately from the optical system 160, receive light transmitted through the optical system 160, and acquire images. Also, the optical system 160 may transmit light to the wafer (refer to 500 in FIG. 2) and transmit light reflected by the wafer to the image acquiring apparatus 180. Alternatively, the optical system 160 may include a light source configured to generate light irradiated to the wafer.

By configuring the optical system 160 and the image acquiring apparatus 180 apart from each other, an appropriate image acquiring apparatus 180 may be selected by using one of various kinds of scan methods. Thus, the usefulness of the wafer inspection apparatus 100b may be improved.

Meanwhile, the focus adjusting unit 150 may be disposed to be interlocked or integrated with the optical system 160. For example, the focus adjusting unit 150 may be disposed between lenses included in the optical system 160 or disposed between the stage 110 and the optical system 160 as shown in FIG. 5A. Also, the focus adjusting unit 150 may be disposed in the optical system 160 and function as a portion of the optical system 160. Here, the focus adjusting unit 150 may also change an optical path with the application of electricity and vary a focal position of light incident to the wafer (refer to 500 in FIG. 2).

FIGS. 6A to 6F are schematic diagrams for explaining scan methods used for a wafer inspection apparatus according to example embodiments. For brevity, FIGS. 6A to 6F illustrate only sensors 134a, 134b, 134c, and 134d and a wafer 500 that is an inspection target.

Scan methods may be broadly classified into a leap-and-scan method and continuous scan methods depending on a method of moving an inspection target and a method of acquiring images. The leap-and-scan method may be a method in which an inspection target moves, stops for shooting, and moves again. A continuous scan method may be a method in which an inspection target keeps moving and shooting occurs without stopping. The continuous scan method may be variously classified according to a shooting method.

FIG. 6A illustrates a leap-and-scan method. In the leap-and-scan method, a wafer 500 that is an inspection target may move in a first direction (x direction) by using the stage (refer to 110 in FIG. 2) and stop in a shooting position. While the wafer 500 stops, a CCD sensor 134a may shoot a pattern formed on the wafer 500. After the CCD sensor 134a shoots the pattern, the wafer 500 may move again. In FIGS. 6A to 6F, the right rectangular shape indicates an image acquired by using a leap-and-scan method.

FIG. 6B illustrates an on-time scan method, which is one of the continuous scan methods. In the on-time scan method, unlike in the leap-and-scan method, the wafer 500 may keep moving without stopping, and the CCD sensor 134a may shoot a pattern formed on the wafer 500 at fixed time points to acquire images. In other words, the on-time scan method may be a method in which at a time point when a pattern (e.g., ‘S’) to be shot passes the center of the CCD sensor 134a, the CCD sensor 134a shoots the pattern ‘S’ formed on the wafer 500.

FIG. 6C illustrates a TDI scan method, which is one of the continuous scan methods. In the TDI scan method, the wafer 500 may keep moving without stopping similar to the on-time scan method. However, a pattern may be shot several times at predetermined time intervals by using a TDI sensor 134b including a plurality of line-shaped pixels Px, and images acquired due to the respective shooting operations may be overlapped to acquire one clear image. In the TDI scan method, since the same pattern is shot during every shooting operation, rear pixels may be used to shoot the pattern a little later than front pixels according to a motion speed of the wafer 500. A term “Time Delay” is derived from the above-described characteristic. In the TDI scan method, since the same pattern is shot several times and a clear image is acquired by overlapping images acquired by shooting the pattern several times, it may be important or significant to synchronize a shooting speed of the TDI sensor 134b with a motion speed of the inspection target. In FIG. 6C, the arrow on the wafer 500 indicates a first motion direction Xm, which is a scan direction. Also, the plurality of lower drawings of FIG. 6C show that the pattern is continuously shot on a shooting area including the plurality of line-shaped pixels Px.

Meanwhile, the scan methods shown in FIGS. 6A to 6C may be referred to as an area illumination type because a shooting operation is performed while illuminating a region having a predetermined width.

FIG. 6D shows a spot scan method, which is one of the continuous scan methods. In the spot scan method, a pattern formed on the wafer 500 may be continuously spot-shot by using a photo multiplier tube (PMT) or photodiode (PD) array sensor 134c to acquire images. Spot-shooting may refer to shooting a very narrow region corresponding to a spot. The spot scan method may include overlapping images acquired by continuously performing a spot-shooting operation to acquire an image. As indicated by a first motion direction Xm and a second motion direction Ym, the spot scan method may include performing a shooting operation by reciprocating a shooting target in the first direction (x direction) and moving the shooting target in the second direction (y direction). The lower rectangular shape shows that a pattern is shot on array pixels Pxa.

FIG. 6E shows a multi-spot scan method, which is one of the continuous scan methods. Although the multi-spot method is similar to the spot scan method, the multi-spot method may differ from the spot scan method in that a plurality of spot shooting operations are performed at one time. That is, a spot scan method may include continuously performing one spot shooting operation, while a multi-spot scan method may include continuously performing a plurality, of spot shooting operations at the same time. In FIG. 6E, each spot shooting operation is indicated by a dark spot. Thus, in the multi-spot scan method of FIG. 6E, it can be seen that four spot shooting operations are performed at the same time.

The multi-spot method may be similar to the spot scan method in that the PMT or PD array sensor 134c is used and a shooting target moves in a first motion direction Xm and a second motion direction Ym. Since the multi-spot scan method is performed using a plurality of spot shooting operations, an image of the entire pattern may be acquired at a high or higher speed.

FIG. 6F shows a line scan method, which is one of the continuous scan methods. In the line scan method, a pattern formed on the wafer 500 may be continuously shot by line-shaped pixels by using a line scan CCD sensor 134d, and shot images may be overlapped to acquire an image. A line scan method may differ from a spot scan method in that a shoot operation is performed in a line shape instead of a spot shape. As indicated by the dark bar, since a line shape has a wider shooting range than a spot shape, the line scan method may be performed more at higher speed than the spot scan method.

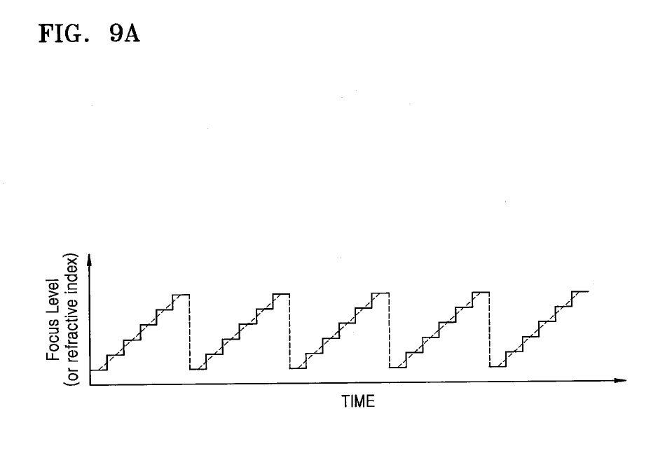

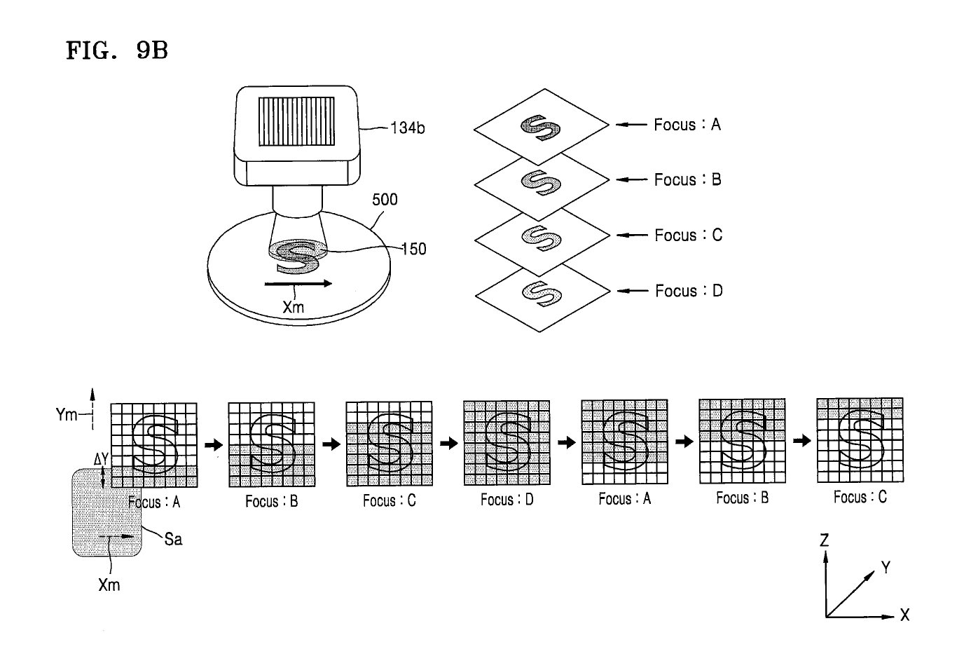

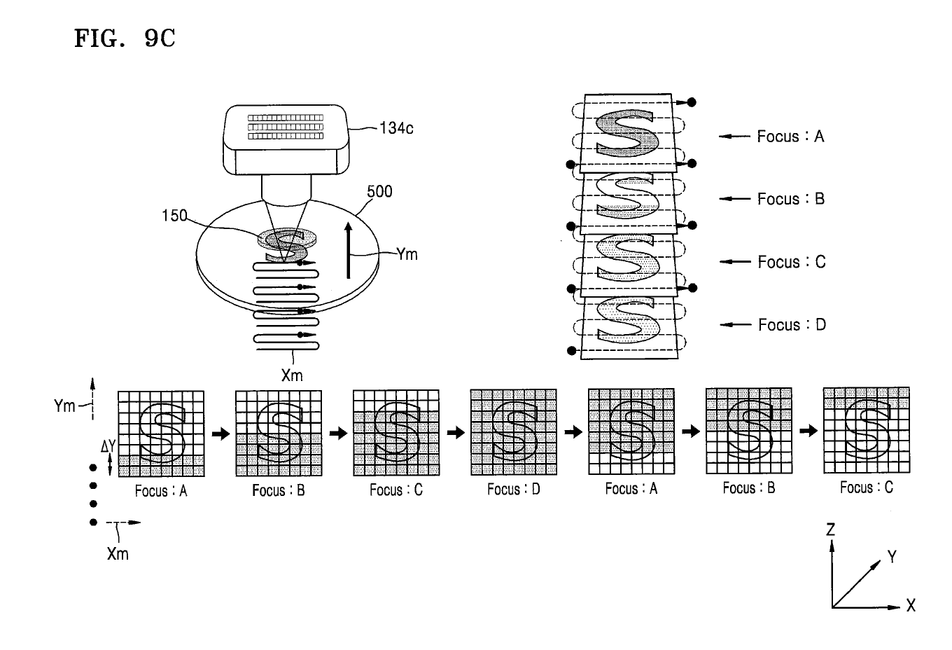

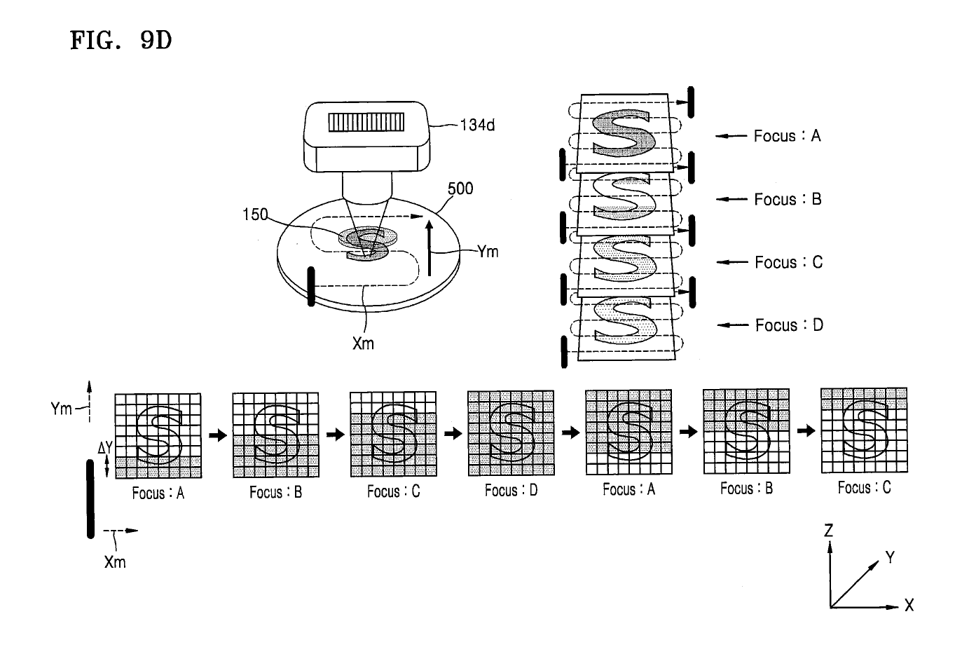

Meanwhile, a line scan CCD sensor may be similar to a TDI sensor in that pixels have a line shape. However, since the line scan CCD sensor performs a shooting operation while moving in the first motion direction Xm and the second motion direction Ym similar to a spot sensor, a length of a shooting target obtained in the second direction (y direction) may not be specifically limited. By comparison, since the TDI sensor moves only in the first motion direction (refer to Xm in FIG. 6C), a length of the shooting target obtained in the second direction (y direction) may be limited. Also, the line scan CCD sensor may have a narrow shooting area in the first direction (x direction), while the TDI sensor may have line-shaped pixels but have a relatively wide shooting area in the first direction (x direction) (refer to Sa in FIG. 9B). Furthermore, since the line scan CCD sensor has a short exposure time, an illuminator having a high luminance may be required, and it may be difficult to apply the line scan CCD sensor to a high-speed application. By comparison, the TDI sensor may use an illuminator having a lower luminance than the line scan CCD sensor and be applied to a high-speed application to which the line scan CCD sensor may not be easily applied.

The scan methods shown in FIGS. 6D to 6F may be referred to as a line or spot illumination type because a shoot operation is performed while illuminating the wafer 500 serving as an inspection target in a spot or line shape.

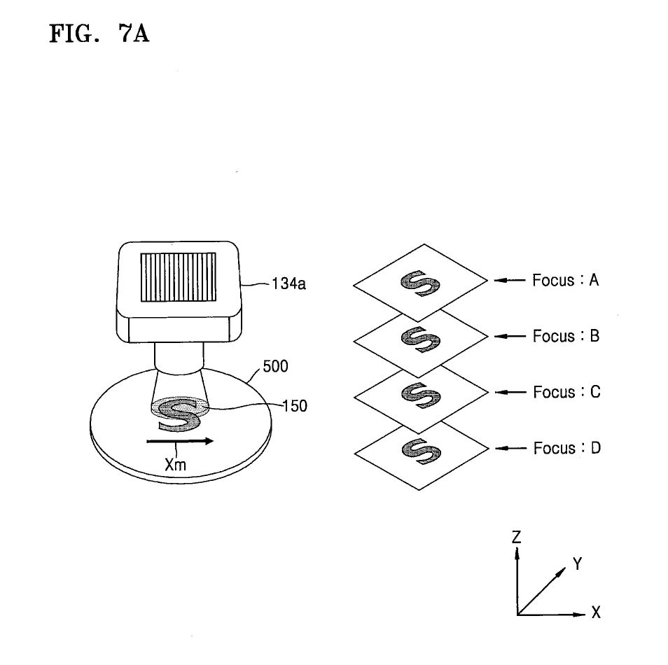

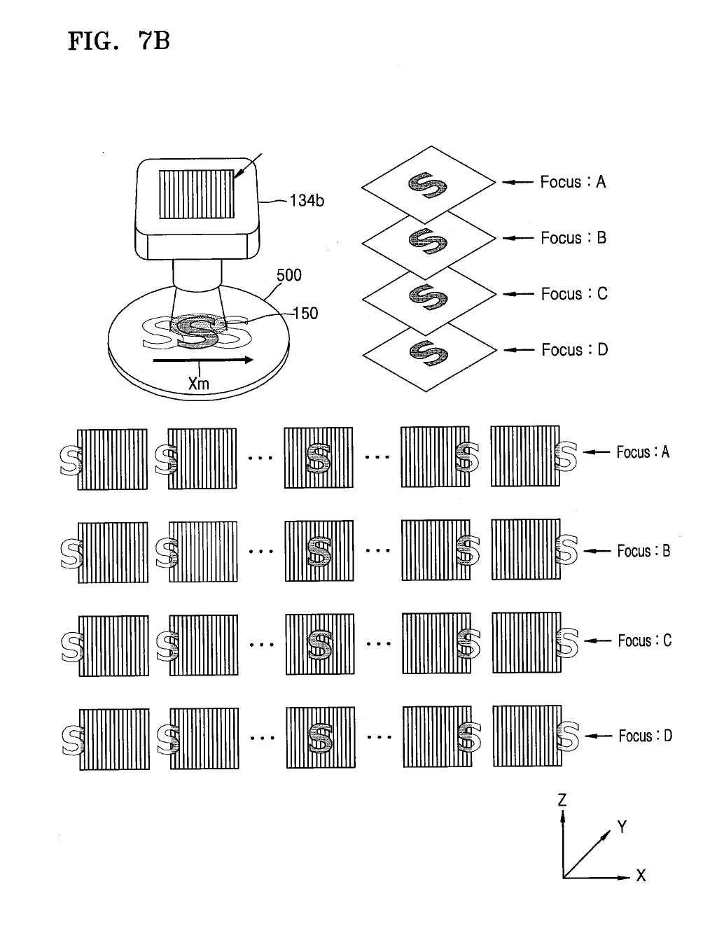

FIGS. 7A and 7B are schematic diagrams for explaining a method of performing a scan operation while changing a focal position in a wafer inspection apparatus according to example embodiments. For brevity, FIGS. 7A and 7B illustrate only sensors 134a and 134b, a focus adjusting unit 150, and a wafer 500, and the focus adjusting unit 150 is simply illustrated as a circular plate type.

Referring to FIG. 7A, in the present embodiment, a scan operation may be performed while changing a focal position by using the wafer inspection apparatus 100 shown in FIG. 1. Naturally, the scan operation is not limited to using the wafer inspection apparatus 100 of FIG. 1. For example, the scan operation may be performed by using the wafer inspection apparatuses 100a and 100b shown in FIGS. 5B and 5C.

In the present embodiment, a scan method may be a leap-and-scan method or an on-time scan method. Thus, by use of the CCD sensor 134a, the wafer 500 that is an inspection target may be shot in a stopped state or shot at fixed time points while moving. Also, the wafer 500 may be shot while changing a focal position by using the focus adjusting unit 150.

More specifically, initially, a shooting operation may be performed at a first focal position (Focus: A) by using a leap-and-scan method or an on-time scan method to acquire a first image of the wafer 500. Next, a focal position may be changed from the first focal position (Focus: A) into a second focal position (Focus: B) by the focus adjusting unit 150, and a shooting operation may be performed again by using the leap-and-scan method or the on-time scan method to acquire a second image of the wafer 500. A shooting operation may be performed while changing a focal position into set focal positions. In FIGS. 7A and 7B, the right rectangular shapes indicate images acquired in respective focal positions by using a leap-and-scan method or an on-time scan method. Although FIG. 7A shows examples of images acquired in four focal positions (Focus: A, Focus: B, Focus: C, and Focus: D), the number of focal positions is not limited to 4. For example, five or more focal positions may be set. In some cases, two or three focal positions may be set.

In the scan operation according to the present embodiment, a focal position may be electrically performed by the focus adjusting unit 150. For example, as described with reference to FIGS. 3A to 4B, a refractive index may be changed by applying electricity by using an AO device or an LC device so that a focal position may be changed at a high speed. Since the focal position may be changed within a range of about several μs to several ms with the application of electricity, in the leap-and-scan method, the focal positions may be wholly changed by applying electricity in a stopped state so that an image of the wafer 500 may be acquired in each focal position at a high speed. Meanwhile, the on-time scan method may be repeated an equal number of times as the set number of focal positions.

Referring to FIG. 7B, a scan method according to the present embodiment may be a TDI scan method. Thus, the wafer 500 that is an inspection target may be shot several times by the TDI sensor 134b, and images acquired due to respective shooting operations may be overlapped to acquire one clear image. Also, the wafer 500 may be shot while changing a focal position by the focus adjusting unit 150.

More specifically, initially, a shooting operation may be performed in a first focal position (Focus: A) by using a TDI scan method to acquire a first image of the wafer 500. Next, a focal position may be changed from the first focal position (Focus: A) into a second focal position (Focus: B) by the focus adjusting unit 150, and a shooting operation may be performed again in the second focus portion (Focus: B) by using the TDI scan method to acquire a second image of the wafer 500. A shooting operation may be continuously performed while changing the focal position into set focal positions. In FIG. 7B, the lower drawings show that a pattern is continuously shot on a shooting area including line-shaped pixels Px. The TDI scan method may be repeated an equal number of times to the number of set focal positions as shown in FIG. 7B.

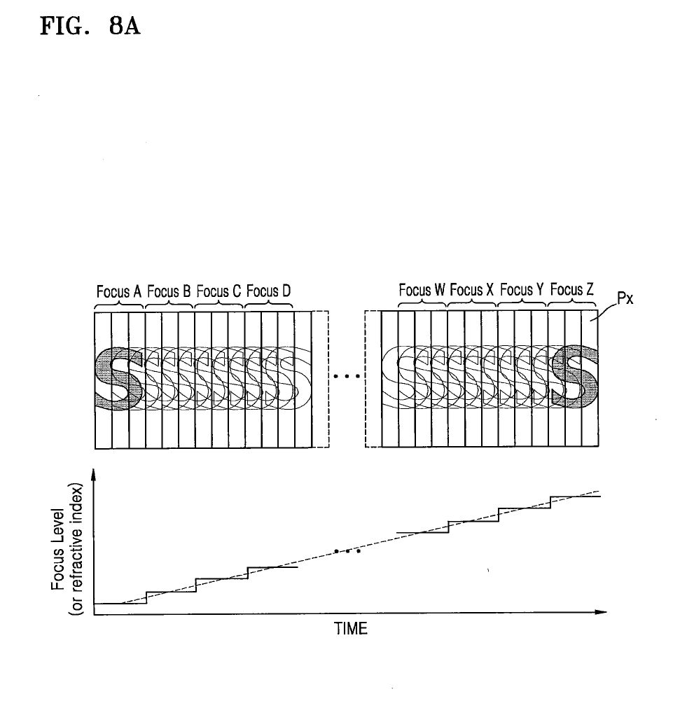

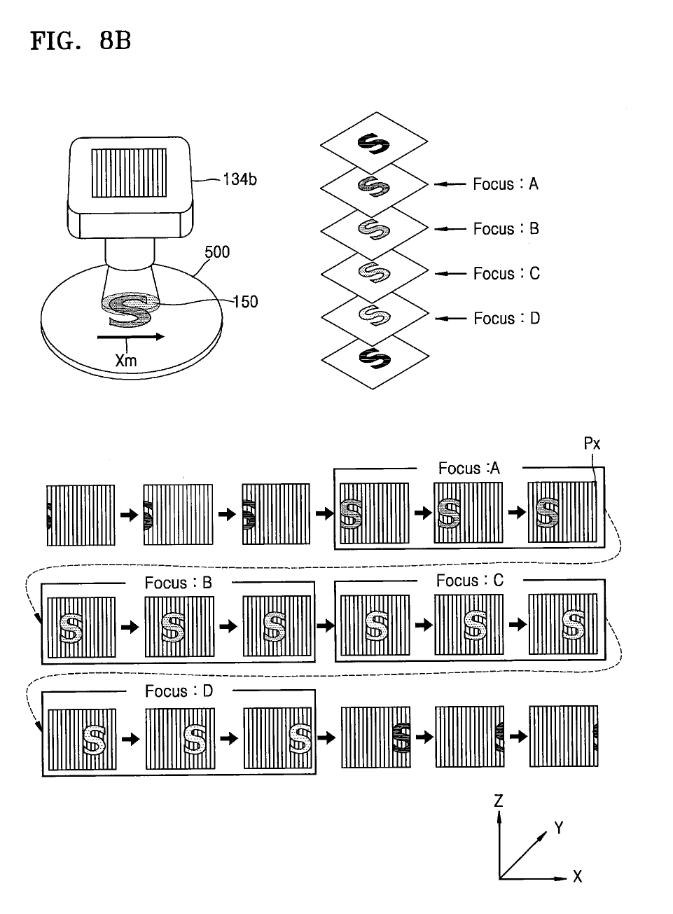

FIG. 8A is a graph showing that a focal position is changed at predetermined time intervals in a wafer inspection apparatus according to example embodiments. In FIG. 8A, the abscissa denotes a time, and the ordinate denotes a focal position.

As shown in FIG. 8A, a focal position may be sequentially changed at predetermined time intervals. A time interval at which the focal position is changed may be variously determined according to performance of the focus adjusting unit (refer to 150 in FIG. 8B). For example, the time interval at which the focal position is changed may be set to about several ms or an even shorter amount of time, for example, several μs or several tens of μs. Meanwhile, since a focal position is changed by changing a refractive index due to application of electricity, the focal position may adjust to the refractive index. Thus, in the graph of FIG. 8A, the ordinate denotes the refractive index as well as the focal position.

FIG. 8A illustrates an example in which a focal position is changed 26 times from a first focal position (Focus A) to a twenty-sixth focal position (Focus Z) (counting initially changing a focal position to the first focal position (Focus A) as one time), but the number of times the focal position is changed is not limited thereto. For example, the focal position may be changed 25 times or less or 27 times or more. The upper drawing of FIG. 8A shows that a pattern is continuously shot by pixels Px of a sensor (e.g., a TDI sensor) according to each focal position.

Meanwhile, all changes in the focal positions may be performed during a one-time scan operation. That is, the focal position may be changed all of a required number of times during the one-time scan operation. Thus, the focal position may be sequentially increased or reduced while the focal position is being changed all the required number of times. In other words, the focal position may be neither increased and then reduced nor reduced and then increased during the one-time scan operation.

FIG. 8B is a schematic diagram showing that a principle on which the focal position of FIG. 8A is changed is applied to a TDI scan method. For brevity, FIG. 8B illustrates only a sensor 134b, a focus adjusting unit 150, and a wafer 500, and the focus adjusting unit 150 is simply illustrated as a circular plate type.

Referring to FIG. 8B, in a wafer inspection apparatus according to the present embodiment, a scan method may be a TDI scan method, and a focal position may be sequentially changed at predetermined time intervals. In the TDI scan method according to the present embodiment, a focal position may be changed four times. For example, when initially changing a focal position to a first focal position (Focus: A) is counted as one time, the focal position may be changed three more times and changed into a fourth focal position (Focus: D). However, the number of times the focal position is changed is not limited to 4. The focal position may be changed at very short time intervals, for example, time intervals of several μs or several tens of μs.

Meanwhile, the lower portion of FIG. 8B illustrates that a pattern is continuously shot on shooting areas including pixels Px of the TDI sensor 134b in each focal position. Front and rear shooting areas on which the entire pattern is not shown may be excluded from an analysis process. Meanwhile, one image is acquired by overlapping several images acquired by shooting the pattern several times in each focal position, and illustrated according to each focal position in the right rectangular portion.

In the TDI scan method according to the present embodiment, unlike the TDI scan method of FIG. 7B, a focal position may be changed all of a required number of times during a one-time TDI scan operation. Thus, as in FIG. 7B, when the one-time TDI scan operation is allowed to correspond to shooting areas on one line, although shooting areas are illustrated on three lines in the TDI scan method according to the present embodiment, the one-time TDI scan operation may actually correspond to the shooting areas on one line. Also, the one-time scan operation may be inferred from connection of the shooting areas with dotted arrows.

Therefore, the TDI scan method of FIG. 7B may differ from the TDI scan method according to the present embodiment as follows. That is, in the TDI scan method of FIG. 7B, a fixed focal position may be maintained during a one-time TDI scan operation, and a new TDI scan operation may be performed again by changing a focal position. Accordingly a TDI scan operation may be performed the same number of times as the number of focal positions. In contrast, in the TDI scan method according to the present embodiment, the entire operation of changing a focal position a required number of times may be performed during a one-time TDI scan operation. Accordingly, when the one-time TDI scan operation ends, the operation of changing the focal position may end, and all images of the wafer 500 may be acquired in changed focal positions.

Meanwhile, since the TDI scan method according to the present embodiment includes performing the entire operation of changing the focal position during the one-time TDI scan operation, as described with reference to FIG. 8A, the focal position may be sequentially increased or reduced all the required number of times. Also, in the TDI scan method according to the present embodiment, the focal position may be changed at shorter time intervals than in the TDI scan method of FIG. 7B. For example, the TDI scan method according to the present embodiment may be performed by changing a focal position at time intervals of several μs or several tens of μs, while the TDI scan method of FIG. 7B may be performed by changing a focal position at time intervals of several ms. Naturally, time intervals at which a focal position is changed are not limited to the above-described numerical values.

FIG. 9A is a graph showing that a focal position is periodically changed in a wafer inspection apparatus according to example embodiments. In FIG. 9A, the abscissa denotes a time, and the ordinate denotes a focal position.

As shown in FIG. 9A, a focal position may be sequentially changed at predetermined time intervals. Also, an operation of sequentially changing the focal position may be repeated with a predetermined cycle. More specifically, a focal position may be sequentially increased from an initial position to a final position. After the focal position is increased to the final position, the focal position may return to the initial position and increase again. A variation in focal position may be repeated as described above. In contrast, a focal position may be sequentially reduced from an initial position to a final position. After the focal position is reduced to the final position, the focal position may return to the initial position and be reduced again.

The above-described aspect of a change in focal position may occur when the change in focal position is limited within a specific range. For example, a range in which a focal position is changed with a change in refractive index may be limited due to characteristics of an AO device or an LC device. Also, a range in which a focal position is changed may be limited due to analysis accuracy or an analysis purpose. Thus, when the range in which the focal position is changed is limited, a focal position may be changed only within the limited range. Accordingly, when an operation of changing a focal position cannot be performed on the entire area by sequentially changing the focal position from an initial position to a final position, an operation of sequentially changing the focal position from the initial position to the final position may be defined as one cycle, and the focal position may be changed by repeating the cycle several times.

FIGS. 9B to 9D are schematic diagrams showing that a principle on which the focal position of FIG. 9A is changed is applied to each of a TDI scan method, a multi-spot scan method, and a line scan method. For brevity, FIGS. 9B to 9D illustrate only sensors 134b, 134c, and 134d, a focus adjusting unit 150, and a wafer 500, and a focus adjusting unit 150 is simply illustrated as a circular plate type.

Referring to FIG. 9B, in a wafer inspection apparatus according to the present embodiment, a scan method may be a TDI scan method, and a focal position may be sequentially changed at predetermined time intervals. Also, a cycle including an operation of sequentially changing the focal position may be repeated a predetermined number of times. For example, in the TDI scan method according to the present embodiment, the focal position may be changed four times during a first cycle, and changed three times during a second cycle.

More specifically, in a first stage, a first TDI scan operation may be performed by using a shooting width of a first width ΔY in a second direction (y direction) in a first focal position (Focus: A). In a second stage, a focal position may be changed into a second focal position (Focus: B), and a second TDI scan operation may be performed by using a shooting width of a second width (2*ΔY). In a third stage, the focal position may be changed into a third focal position (Focus: C), and a third TDI scan operation may be performed by using a shooting width of a third width (3*ΔY). In a fourth stage, the focal position may be changed into a fourth focal position (Focus: D), and a fourth TDI scan operation may be performed by using a shooting width of a fourth width (4*ΔY). The first to fourth TDI scan operations may correspond to a first cycle. For reference, the fourth width (4*ΔY) may correspond to a width of a TDI scan shooting area Sa, which is obtained in the second direction (y direction). The TDI scan shooting area Sa is illustrated as a hatched rectangular type in a left lower portion of FIG. 9B.

Meanwhile, scan regions corresponding to respective focal positions may overlap one another. For example, a scan region corresponding to a first focal position (Focus: A) may overlap scan regions corresponding to second to fourth focal positions (Focus: B, Focus: C, and Focus: D), the scan region corresponding to the second focal position (Focus: B) may overlap the scan regions corresponding to the third and fourth focal positions (Focus: C and Focus: D), and the scan region corresponding to the third focal position (Focus: C) may overlap the scan region corresponding to the fourth focal position (Focus: D).

After the fourth TDI scan operation ends, in a fifth stage, the focal position may be changed again into the first focal position (Focus: A), and a fifth TDI scan operation may be performed by using a shooting width of a third width (3*ΔY). In a sixth stage, a focal position may be changed into the second focal position (Focus: B), and a sixth TDI scan operation may be performed by using a shooting width of a second width (2*ΔY). In a seventh stage, the focal position may be changed into the third focal position (Focus: C), and a seventh TDI scan operation may be performed by using a shooting width of a first width (ΔY). The fifth to seventh TDI scan operations may correspond to a second cycle.

The lower drawings of FIG. 9B show that an ‘S’ pattern is shot by pixels while changing a focal position during the first and second cycles. Referring to FIG. 9B, it may be confirmed that the entire ‘S’ pattern may be shot in each focal position by shooting the ‘S’ pattern while changing the focal position during the first and second cycles. In other words, the entire ‘S’ pattern may be shot in the first focal position (Focus: A) due to the first and fiftli TDI scan operation, the entire ‘S’ pattern may be shot in the second focal position (Focus: B) due to the second and sixth TDI scan operations, and the entire ‘S’ pattern may be shot in the third focal position (Focus: C) due to the third and seventh TDI scan operations. Finally, the entire ‘S’ pattern may be shot in the fourth focal position (Focus: D) due to the fourth TDI scan operation.

If a width of a pattern of an inspection target, which is obtained in the second direction (y direction), is greater than a width of the TDI scan shooting area Sa, which is obtained in the second direction, a cycle or number of cycles of the TDI scan operation may increase. For example, if the width of the pattern of the inspection target, which is obtained in the second direction, is 10*ΔY, the focal position may be changed during four cycles. That is, the focal position may be changed 4 times during each of the first to third cycles, and changed once during the fourth cycle. Thus, the TDI scan operation may be performed all thirteen times. Also, the entire pattern of the inspection target may be shot in the first focal position (Focus: A) due to the first, fifth, ninth, and thirteenth TDI scan operations, the entire pattern of the inspection target may be shot in the second focal position (Focus: B) due to the second, sixth, and tenth TDI scan operations, and the entire pattern of the inspection target may be shot in the third focal position (Focus: C) due to the third, seventh, and eleventh TDI scan operations. Finally, the entire pattern of the inspection target may be shot in the fourth focal position (Focus: D) due to the fourth, eighth, and twelfth TDI scan operations.

In the TDI scan method according to the present embodiment, a scan operation may be performed in one direction, for example, a first direction (x direction), or reciprocate in two directions. When the scan operation is performed in one direction, a focal position may be changed while the focal position is returning to an initial position. Also, when the scan operation reciprocates in two directions, the focal position may be changed at a turning point in which a direction of the scan operation is changed. As described above, the focal position may be changed by applying electricity at intervals of a very short amount of time, for example, several μs or several tens of μs.

Referring to FIG. 9C, in a wafer inspection apparatus according to the present embodiment, a scan method may be a multi-spot scan method, and a focal position may be sequentially changed at predetermined time intervals. Also, a cycle including an operation of sequentially changing the focal position may be repeated a predetermined number of times. For example, in the multi-spot scan method according to the present embodiment, the focal position may be changed four times during a first cycle, and changed three times during a second cycle.

The multi-spot scan method according to the present embodiment may be based on the same principle as the TDI scan method of FIG. 9B except that the multi-spot scan method uses a PMT array sensor (or PD array sensor) 134c instead of the TDI sensor (refer to 134b in FIG. 9B). In other words, the multi-spot scan method may include performing a plurality of spot shooting operations, for example, four spot shooting operations by using a predetermined shooting width ΔY in a second direction (y direction) in respective focal positions. Here, the shooting width ΔY may correspond to the number of spot shooting operations. For instance, the shooting width ΔY may correspond to one or two spot shooting operations.

Assuming that the multi-spot scan method according to the present embodiment includes performing four spot shooting operations and the shooting width ΔY in the second direction (y direction) corresponds to one spot shooting operation, in a first stage, a first scan operation may be performed by using one spot shooting operation in a first focal position (Focus: A). In a second stage, a focal position may be changed into a second focal position (Focus: B), and a second scan operation may be performed by using two spot shooting operations. In a third stage, the focal position may be changed into a third focal position (Focus: C), and a third scan operation may be performed by using three spot shooting operations. In a fourth stage, the focal position may be changed into a fourth focal position (Focus: D), and a fourth scan operation may be performed by using four spot shooting operations. The first to fourth scan operations may correspond to a first cycle.

After the fourth scan operation is ended, in a fifth stage, the focal position may be changed again into the first focal position (Focus: A), and a fifth scan operation may be performed by using three spot shooting operations. In a sixth stage, the focal position may be changed into the second focal position (Focus: B), and a sixth scan operation may be performed by using two spot shooting operations. In a seventh stage, the focal position may be changed into the third focal position (Focus: C), and a seventh scan operation may be performed by using one spot shooting operation. The fifth to seventh scan operations may correspond to a second cycle.

The lower drawings of FIG. 9C show that an ‘S’ pattern is shot by pixels while changing the focal position during the first and second cycles. In the multi-spot scan method, it may also be confirmed that the entire ‘S’ pattern may be shot in each focal position by shooting the ‘S’ pattern while changing the focal position during the first and second cycles. Also, similar to the TDI scan method, if a width of a pattern of an inspection target, which is obtained in the second direction (y direction), increases, a cycle or number of cycles of a multi-spot scan operation may increase.

Meanwhile, if one spot-shooting size is smaller than the shooting width ΔY, as indicated by a first motion direction Xm, a scan operation may be performed by reciprocating the inspection target in the first direction (x direction). Also, the shooting width ΔY is not limited to one or two spot shooting operations but may correspond to at least three spot shooting operations. For reference, four multi-spots are illustrated with dark dots in the first motion direction Xm, in the left lower portion, and the right rectangular images of FIG. 9C. In the multi-spot scan method according to the present embodiment, a scan operation may be performed by reciprocating the inspection target in two directions along the first direction (x direction), and the focal position may be changed at a turning point in which a direction of the scan operation is changed.

Referring to FIG. 9D, in a wafer inspection apparatus according to the present embodiment, a scan method may be a line scan method, and a focal position may be sequentially changed at predetermined time intervals. Also, a cycle including an operation of sequentially changing the focal position may be repeated a predetermined number of times. For example, in the line scan method according to the present embodiment, the focal position may be changed four times during a first cycle, and changed three times during a second cycle.

The line scan method according to the present embodiment may be based on the same principle as the TDI scan method of FIG. 9B or the multi-spot scan method of FIG. 9C except that the line scan method uses a line scan CCD sensor 134d instead of the TDI sensor (refer to 134b in FIG. 9B) or the PMT array sensor (or PD array sensor) (refer to 134c in FIG. 9C). In other words, in the line scan method, scan operations may include continuously performing shooting operations by using line-shaped pixels, and performed by using a predetermined shooting width ΔY in a second direction (y direction) in respective focal positions. Thus, as described above in the TDI scan method of FIG. 9B or the multi-spot scan method of FIG. 9C, four line scan operations performed in a first focal position (Focus: A) to a fourth focal position (Focus: D) may correspond to a first cycle, and three line scan operations performed in the first focal position (Focus: A) to a third focal position (Focus: C) may correspond to a second cycle.

The lower drawings of FIG. 9D show that an ‘S’ pattern is shot by pixels while changing the focal position during the first and second cycles. In the line scan method, it may also be confirmed that the entire ‘S’ pattern may be shot in each focal position by shooting the ‘S’ pattern while changing the focal position during the first and second cycles.

Similar to the TDI scan method or the multi-spot scan method, if a width of a pattern of an inspection target, which is obtained in the second direction (y direction), increases, a cycle or number of cycles of a line scan operation may increase. Also, if a size of a line-shaped pixel in the second direction (y direction) is smaller than the shooting width ΔY, as indicated by a first motion direction Xm, a line scan operation may be performed in the second direction (y direction) by reciprocating the inspection target in the first direction (x direction). For reference, line-shaped pixels are illustrated with dark rods in the first motion direction Xm, in the left lower portion, and the right rectangular images of FIG. 9D. In the line scan method according to the present embodiment, when a scan operation is performed by reciprocating the inspection target in two directions along the first direction (x direction), the focal position may be changed at a turning point in which a direction of the scan operation is changed.

While the inventive concept has been particularly shown and described with reference to example embodiments thereof, it will be understood that various changes in form and details may be made therein without departing from the spirit and scope of the following claims.

What is claimed is:

1. A wafer inspection apparatus comprising:
a stage on which a wafer is disposed;
an optical apparatus configured to acquire an image of a pattern formed on the wafer by using a scan operation;
a focus adjusting unit configured to change a focal position of light irradiated to the wafer according to a scan speed of the optical apparatus; and
an image processor configured to integrate images corresponding to focal positions and generate and analyze 3-dimensional (3D) images.

2. The apparatus of claim 1, wherein the optical apparatus comprises an optical system configured to irradiate light to the wafer and a sensor configured to receive light reflected by the wafer,
wherein the focus adjusting unit is configured to electrically control an optical path of the light irradiated to the wafer and change the focal position.

3. The apparatus of claim 2, wherein the focus adjusting unit comprises an acoustic-optic (AO) device or a liquid crystal (LC) device of which a refractive index is changed by applying electricity.

4. The apparatus of claim 1, wherein the focus adjusting unit is configured to electrically control an optical path of light and change the focal position,
wherein the focus adjusting unit changes the focal position with a predetermined cycle.

5. The apparatus of claim 4, wherein the focal position is gradually increased or reduced from an initial position to a final position during the predetermined cycle.

6. The apparatus of claim 5, wherein the optical apparatus performs the scan operation in a second direction perpendicular to a first direction while reciprocating in the first direction, and
the focus adjusting unit is configured to change the focal position at a turning point in which a direction of the scan operation is reversed in the first direction.

7. The apparatus of claim 5, wherein when the scan operation is continued after the focal position is changed to the final position, the focus adjusting unit is configured to change the focal position to the initial position and then gradually increase or decrease the focal position again.

8. The apparatus of claim 5, wherein scan regions respectively corresponding to the focal positions overlap one another.

9. The apparatus of claim 1, wherein the optical apparatus comprises an optical system configured to irradiate light to the wafer and a sensor configured to receive light reflected by the wafer,
wherein the sensor is a charged-coupled device (CCD) sensor is configured to obtain images by using a leap-and-scan method,
and wherein the focus adjusting unit is configured to change the focal position by electrically controlling an optical path during a period in which the stage is moved.

10. The apparatus of claim 1, wherein the optical apparatus comprises an optical system configured to irradiate light to the wafer and a sensor configured to receive light reflected by the wafer, and
the sensor is any one of a charged-coupled device (CCD) sensor, a time-delayed-integration (TDI) sensor, a photo-multiplier tube (PMT) or photodiode (PD) array sensor, and a line scan CCD sensor, and is configured to obtain an image by using a continuous scan method.

11. The apparatus of claim 10, wherein the continuous scan method is at least one of an on-time scan method, a TDI scan method, a spot scan method, a multi-spot scan method, and a line scan method, and
the focus adjusting unit is configured to change the focal position by electrically controlling an optical path with a predetermined cycle.

12. The apparatus of claim 1, wherein the focus adjusting unit is disposed outside the optical apparatus.

13. A wafer inspection apparatus comprising:
a stage on which a wafer is disposed, wherein the stage is configured to move during a scan operation;
an image acquiring apparatus configured to receive light reflected by the wafer and acquire an image;
an optical system configured to irradiate light to the wafer and transmit the light reflected by the wafer to the image acquiring apparatus;
a focus adjusting unit configured to change a focal position of the light irradiated to the wafer according to a scan speed; and
an image processor configured to integrate images corresponding to focal positions, to generate a 3D image, and to analyze the 3D image.

14. The apparatus of claim 13, wherein the focus adjusting unit comprises:
an acoustic-optic (AO) device or a liquid crystal (LC) device configured to transmit light and of which a refractive index varies with application of electricity; and
a driver configured to supply electricity to the AO device or the LC device.

15. The apparatus of claim 13, wherein the image acquiring apparatus is configured to obtain an image by using a continuous scan method, and
the focus adjusting unit is configured to change the focal position by electrically controlling an optical path with a predetermined cycle.

16. A wafer inspection apparatus comprising:
a stage configured to support a wafer that is an inspection target;
a focus adjusting unit configured to change a focal position of light irradiated to the wafer;
an optical apparatus configured to irradiate light to the wafer at a plurality of focal positions, to receive light reflected from the wafer for each focal position, and to acquire an image for each focal position; and
an image processor configured to receive the plurality of images from the optical apparatus for each focal position, to integrate the images, to generate a 3D image based on the integrated images, and to analyze the 3D image to perform a 3D defect inspection of the wafer.

17. The apparatus of claim 16, wherein the focus adjusting unit is disposed between the stage and the optical apparatus and is configured to electrically control an optical path of the light irradiated to the wafer to change the focal position.

18. The apparatus of claim 17, wherein the focus adjusting unit comprises an acoustic-optic (AO) device or a liquid crystal (LC) device that is configured to change a refractive index thereof in response to the application of electricity to thereby change the focal position.

19. The apparatus of claim 17, wherein the focus adjusting unit is configured to change the focal position in a predetermined cycle in which the focal position is gradually increased or reduced from an initial position to a final position during the predetermined cycle.

20. The apparatus of claim 19, wherein the focus adjusting unit is configured to change the focal position in the predetermined cycle a plurality of times.
